(19) United States
(12) Patent Application Publication
(10) Pub. No.: US 2012/0285808 A1
(43) Pub. Date: Nov. 15, 2012

(54) KEYBOARD STRUCTURE

(76) Inventor: Lai-Shi HUANG, Taipei (TW)

(21) Appl. No.: 13/464,097

(22) Filed: May 4, 2012

Related U.S. Application Data
(60) Provisional application No. 61/484,493, filed on May 10, 2011.

(51) Int. Cl. H01H 13/76

(52) U.S. Cl. 200/5 A

(57) ABSTRACT

A keyboard structure includes a frame, a button, a first circuit unit and a second circuit unit. The frame includes at least a through hole. The button is disposed at the through hole and magnetically connected with the frame. The first circuit unit includes a first electrical contact point disposed corresponding to the button. The second circuit unit includes a second electrical contact point disposed corresponding to the first electrical contact point. When the button is pressed, the button and the frame are separated, and the first electrical contact point contacts with the second electrical contact point.

### CROSS REFERENCE TO RELATED APPLICATIONS

The non-provisional patent application claims priority to U.S. provisional patent application with Ser. No. 61/484,493 filed on May 10, 2011. This and all other extrinsic materials discussed herein are incorporated by reference in their entirety.

### BACKGROUND OF THE INVENTION

1. Field of Invention

The present disclosure relates to a keyboard structure and, in particular, to a keyboard structure with magnetic property.

2. Related Art

As the development of electronic technology, many electronic products, such as laptops, cell phones, or other key-type input devices, are equipped with a keyboard for the user to operate and input.

Regarding to the keyboard structure of a laptop, the complex structure, such as scissor-shaped structure and elastic element, is usually configured to provide the desired feedback as the user presses the button. However, the buttons with this structure are not stable and not tightly configured, and they can not provide good feedback in operation. Besides, the keyboard with this button structure can not be manufactured thinner. In addition, the conventional keyboard structure is complex and includes a lot of components, so that the assembling thereof is labor and time consumption. Thus, the convenience of assembling is unsatisfied, and the assembling cost is relatively higher.

### SUMMARY OF THE INVENTION

The disclosure is to provide a keyboard structure that can improve the convenience of assembling, decrease the assembling cost, and provide better feedback in operation.

A keyboard structure of the disclosure includes a frame, a button, a first circuit unit and a second circuit unit. The frame includes at least a through hole. The button is disposed at the through hole and magnetically connected with the frame. The first circuit unit includes a first electrical contact point disposed corresponding to the button. The second circuit unit includes a second electrical contact point disposed corresponding to the first electrical contact point. When the button is pressed, the button and the frame are separated, and the first electrical contact point contacts with the second electrical contact point.

In the disclosed keyboard structure, the button is connected with the frame by a magnetic force, and when the button is pressed, the button and the frame are separated, and the first electrical contact point contacts with the second electrical contact point. Compared with the conventional art, the disclosed keyboard structure does not include the complex structure such as scissor-shaped and elastic element, so that the assembling procedure can be simplified, thereby further improving the convenience of assembling the keyboard structure and decreasing the assembling time and cost.

In addition, since the frame and button are connected by the attraction of magnetic force, and the magnetic force is in inverse proportion of the square of distance, the user needs to provide larger force in the initial period of pressing the button for detaching the button from the frame. After the button is separated from the frame, the magnetic attraction force therebetween is dramatically decreased. The change of the magnetic force can provide a better pressing feedback to the user, and the button is tightly configured and not loose. Besides, the above configuration can also shorten the pressing stroke of the button, so that the entire thickness of the keyboard structure can be reduced.

### BRIEF DESCRIPTION OF THE DRAWINGS

FIG. 1 is an exploded view of a keyboard structure according to an embodiment of the disclosure;

FIGS. 2A and 2B are sectional side views of the keyboard structure, wherein FIG. 2B shows the keyboard structure under a pressed state; and

FIG. 3 is a sectional side view of another keyboard structure of the disclosure.

### DETAILED DESCRIPTION OF THE INVENTION

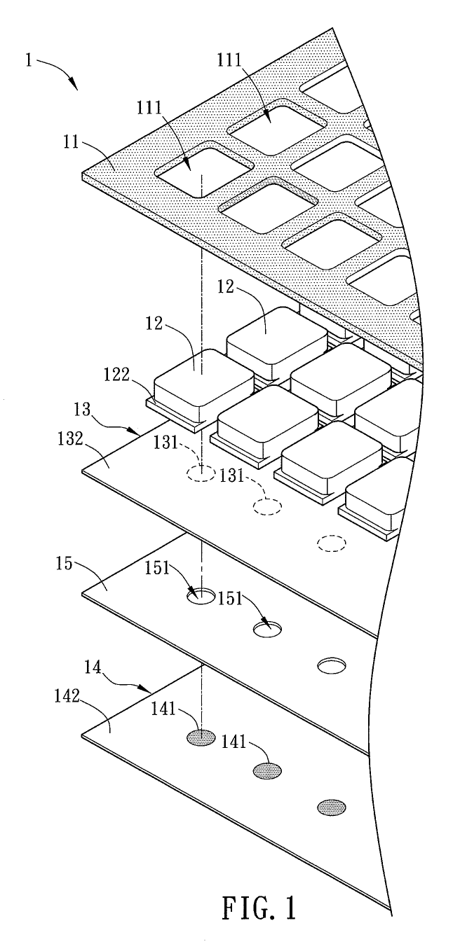

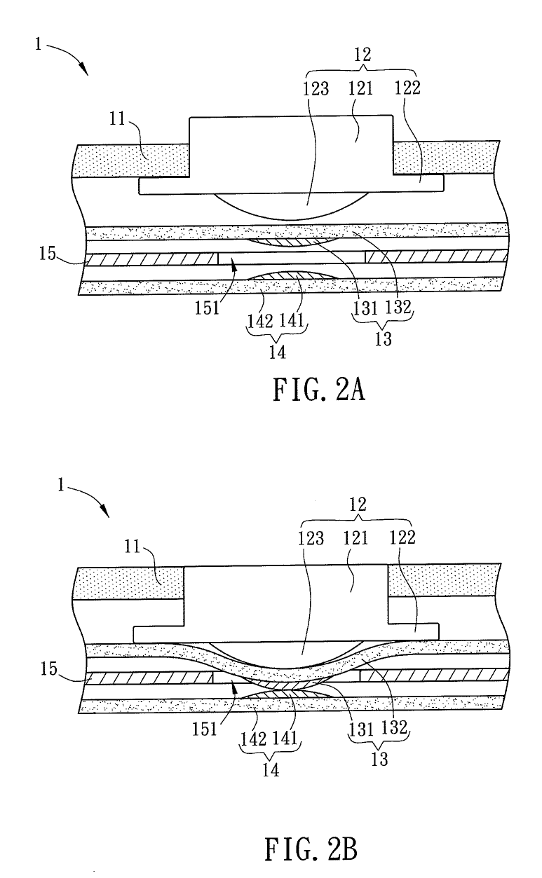

FIG. 1 is an exploded view of a keyboard structure 1 according to an embodiment of the disclosure, and FIGS. 2A and 2B are sectional side views of the keyboard structure 1. Herein, FIG. 2B shows the keyboard structure 1 under a pressed state.

Referring to FIG. 1, the keyboard structure 1 comprises a frame 11 and at least a button 12. Moreover, the keyboard structure 1 further comprises a first circuit unit 13, a second circuit unit 14 and a spacer 15.

The frame 11 includes at least a through hole 111, and the button 12 is correspondingly disposed at the through hole 111. In this case, there are a plurality of buttons 12 arranged corresponding to a plurality of through holes 111.

With reference to FIG. 2A, when the button 12 is not pressed, the button 12 and the frame 11 are connected based on the attractive magnetic force. The button 12 includes a button body 121 and at least an extension portion 122. In this case, the button body 121 is substantially smaller than the through hole 111 and protrudes from the through hole 111. Of course, the button body 121 may not protrude from the through hole 111.

The extension portion 122 is disposed at the periphery of the button body 121, so that the button 12 is connected to the lower edge of the frame 11 by the extension portion 122. Thus, the button 12 can not be departed from the frame 11 upwardly. In this embodiment, two extension portions 122 are respectively configured at two opposite sides of the periphery of the button body 121, and the button body 121 and two extension portions 122 are integrally formed as one piece. Of course, in other aspects, one, three or four extension portions 122 may be configured at the periphery of the button body 121.

In addition, the button body 121 includes a protrusion 123 located on one side of the button 12 away from the frame 11. In this case, the protrusion 123 is located at the center of the lower side of the button body 121. The protrusion 123 may be contact or non-contact with the first circuit unit 13, and the protrusion 123 of this embodiment is non-contact with the first circuit unit 13.

At least one of the frame 11 and the button 12 comprises a magnetic material such as a permanent magnet or a magnetic metal.

In another embodiment, a coil is disposed on the upper edge of the frame 11 or the lower edge of the frame 11 opposite to the extension portion 123. Then, a corresponding magnetic element is configured. After applying current to the coil, the coil can generate a magnetic field. The generated magnetic field and the corresponding magnetic element can induce the attractive or repulsive magnetic force between the frame 11 and the button 12 for adjusting the desired feedback as the button 12 is pressed. In specific, if the attractive magnetic force between the frame 11 and the button 12 is increased, the larger pressing force must be provided to press the button 12 (the feedback is increased).

With reference to FIGS. 1 and 2B, the first circuit unit 13 includes at least one first electrical contact point 131 disposed corresponding to the button 12, and the second circuit unit 14 includes a second electrical contact point 141 disposed corresponding to the first electrical contact point 131. In this case, a plurality of buttons 12 are configured corresponding to a plurality of first electrical contact points 131, and the first electrical contact points 131 are disposed respectively corresponding to the second electrical contact points 141.

In one embodiment, the first circuit unit 13 includes a first substrate 132, and the first electrical contact points 131 are disposed on the first substrate 132. Similarly, the second circuit unit 14 includes a second substrate 142, and the second electrical contact points 141 are disposed on the second substrate 142.

Referring to FIG. 2A, a spacer 15 is disposed between the first circuit unit 13 and the second circuit unit 14. Herein, the spacer 15 can separate and isolate the first circuit unit 13 and the second circuit unit 14, so that the electrical contact points of the first circuit unit 13 and the second circuit unit 14 are not in contact with each other. Besides, the spacer 15 includes at least one opening 151 disposed corresponding to the protrusion 123. Of course, the opening 151 may be disposed corresponding to the first electrical contact point 131 and the second electrical contact point 141.

As shown in FIG. 2A, when the button 12 is not pressed, the protrusion 123 does not push the first circuit unit 13, and the first electrical contact point 131 is not in contact with the second electrical contact point 141. As shown in FIG. 2B, when the button 12 is pressed, the protrusion 123 pushes the first circuit unit 13, and the first electrical contact point 131 moves downwardly to pass through the opening 151, thereby allowing the first electrical contact point 131 to contact with the second electrical contact point 141 of the second circuit unit 14. Accordingly, the keyboard structure 1 can generate the desired corresponding control operation.

With reference to FIG. 2A, after the pressing force applied to the button 12 is removed, the magnetic force between the button 12 and the frame 11 can pull the button 12 upwardly to be separated from the first circuit unit 13 and connected with the frame 11. In addition, the elastic restored force of the first substrate 132 of the first circuit unit 13 may also used to pull the first electrical contact point 131 upwardly so as to separate the first electrical contact point 131 and the second electrical contact point 141.

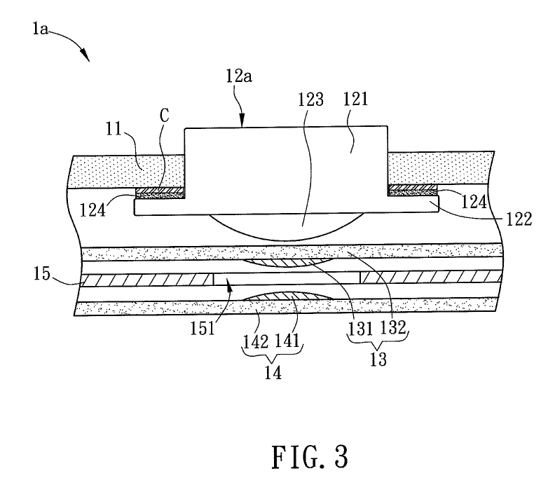

FIG. 3 is a sectional side view of another keyboard structure la of the disclosure.

The difference between the keyboard structures 1 and la is in that the keyboard structure 1 a further comprises a coil C disposed on the lower edge of the frame 11 opposite to the extension portion 123. Besides, a magnetic element 124 (e.g. a permanent magnet) is configured at a corresponding position on the extension portion 123 of the button 12a. After applying current to the coil C to generate a magnetic pole the same as or different from that of the magnetic element 124, the attractive or repulsive magnetic force can be generated for adjusting the desired feedback as the button 12a is pressed.

In summary, the keyboard structure 1 of the disclosure includes less components and does not need the complex structure such as scissor-shaped and elastic element, so that the assembling procedure can be simplified, thereby further improving the convenience of assembling the keyboard structure 1 and decreasing the assembling time and cost.

In addition, since the frame 11 and button 12 are connected by the attraction of magnetic force, and the magnetic force is in inverse proportion of the square of distance, the user needs to provide larger force in the initial period of pressing the button 12 for detaching the button 12 from the frame 11. After the button 12 is separated from the frame 11, the magnetic attraction force therebetween is dramatically decreased. The change of the magnetic force can provide a better pressing feedback to the user. Besides, the above configuration can also shorten the pressing stroke of the button 12, so that the entire thickness of the keyboard structure 1 can be reduced.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. A keyboard structure, comprising:
a frame having at least a through hole;
a button disposed at the through hole and magnetically connected with the frame;
a first circuit unit having a first electrical contact point disposed corresponding to the button; and
a second circuit unit having a second electrical contact point disposed corresponding to the first electrical contact point;
wherein, when the button is pressed, the button and the frame are separated, and the first electrical contact point contacts with the second electrical contact point.

2. The keyboard structure of claim 1, wherein the frame or the button is made of a magnetic material.

3. The keyboard structure of claim 1, further comprising:
a spacer disposed between the first circuit unit and the second circuit unit, wherein the spacer has at least an opening.

4. The keyboard structure of claim 1, wherein the button has a button body and at least an extension portion disposed at the periphery of the button body.

5. The keyboard structure of claim 4, wherein a protrusion is formed at the bottom of the button body and disposed corresponding to the opening.

6. The keyboard structure of claim 1, further comprising:
a coil disposed on the frame or the button.
